(19) United States
(12) Patent Application Publication
(10) Pub. No.: US 2026/0023539 A1
(43) Pub. Date: Jan. 22, 2026

(54) Agentic Large Language Model (LLM) Apparatus and Method for Synthesizable Register Transfer Level (RTL) Code Generation With Progressive Feedback

(71) Applicant: Intel Corporation, Santa Clara, CA (US)

(72) Inventors: Athmanarayanan Lakshmi Narayanan, Sunnyvale, CA (US); Mahesh Subedar, Folsom, CA (US); Omesh Tickoo, Portland, OR (US)

(73) Assignee: Intel Corporation, Santa Clara, CA (US)

(21) Appl. No.: 19/341,343

(22) Filed: Sep. 26, 2025

(51) Int. Cl. G06F 8/35; G06F 11/3668; G06F 16/34

(52) U.S. Cl. CPC G06F 8/35; G06F 11/3688; G06F 16/345

(57) ABSTRACT

An agentic LLM architecture is described for synthesizable register-transfer level (RTL) generation using progressive feedback. A method, for example, is performed by an agentic framework for automated RTL code generation, the method comprising: generating initial RTL code by a large language model (LLM) code generator agent based on a design prompt; executing the RTL code by a code executor agent in accordance with a test bench; generating a validation indication when the initial RTL code can be executed without errors or recording a first one or more detected errors generated during execution of the initial RTL code, evaluating the first one or more detected errors by the LLM code generator agent to generate refined RTL code; and providing the refined RTL code for execution by the code executor agent.

### TECHNICAL FIELD

This invention relates generally to the field of computer processors. More particularly, the invention relates to an agentic LLM apparatus and method for synthesizable RTL generation with progressive feedback.

### BACKGROUND

Agentic (agent-based) large language models (LLMs) have been proposed as an option for solving certain Al-based hardware design challenges. For example, agentic AI Exploratory Data Analysis (EDA) workflows have the potential to significantly reduce the time and effort required for hardware development. Existing efforts to augment LLM models for AI -based hardware design do not scale well, and lack a cohesive integration of register-transfer level (RTL) code development tools, requiring significant human effort.

### BRIEF DESCRIPTION OF THE DRAWINGS

A better understanding of the present invention can be obtained from the following detailed description in conjunction with the following drawings, in which:

FIG. 1 illustrates an example implementation with agentic LLM-based RTL code generation.

FIG. 2 illustrates an example set of prompts and template configurations in accordance with some implementations.

FIG. 3 illustrates a method in accordance with some embodiments for providing progressive error feedback.

FIG. 4 illustrates a system on which embodiments of the disclosure may be implemented.

### DETAILED DESCRIPTION OF EMBODIMENTS

Various implementations of this disclosure include an agent-based framework for efficiently collaborating to solve complex hardware design tasks, including, but not limited to, those associated with power consumption, performance, and area (PPA) of a target hardware design. In particular, the agent-based frameworks described herein implement PPA-aware register-transfer level (RTL) code generation and testbench creation to accelerate design space exploration while minimizing human effort. Self-reflection operations, reasoning using data from multiple agents translated into control signals, and trigger points to instruct the agentic components provide flexibility in these implementations. Errors from compilation tools are progressively evaluated to prevent token explosion and reduce the potential for hallucinations. Additionally, specification-to-RTL tasks and RTL code completion tasks can be implemented in models using significantly fewer LLM calls than current implementations, enabling real-time use cases. These implementations are also agnostic to open or closed source models and are invariant to temperature or heuristics.

The agents of the agentic framework described herein can also be tasked with generating software stacks and/or code transpilation (converting source code written in one programming language into source code in another programming language). For example, in accordance with some implementations, C++/CUDA code may be cross-compiled to specific platforms. These implementations have demonstrated significant improvements in hardware development efforts to create a derivative product from a main product, from initial tape-out (A0 silicon) to final production.

In operation, implementations of the agentic framework for generating RTL code iteratively incorporate feedback from compilers and linting tools (i.e., specialized tools/commands to automatically analyze Verilog code for potential issues). The embodiments described herein may be integrated within compilers and tools in collaboration with external design automation partners to realize a fully integrated end-to-end solution. An agentic chip design flow can be used with a large volume of data available from multiple generations of products that can be accessed in a Retrieval-Augmented Generation (RAG) flow.

By way of an overview, existing solutions in this space include (1) LLM-based code generation methods, (2) Monte Carlo Tree Search (MCTS)-based RTL generation, (3) agentic systems for RTL generation, (4) LLM-based code generation methods, (5) MCTS-based RTL generation, (6) agentic systems for RTL generation.

LLM-based code generation methods include general-purpose code generation with LLMs, spanning tasks such as code completion, natural language-to-code translation, bug detection, and security vulnerability identification. Recent studies have explored applying LLMs to RTL generation, despite significant challenges such as limited datasets and scarce public IP availability.

Monte Carlo Tree Search (MCTS)-based RTL code generation approaches employ reward-driven search strategies to optimize RTL generation. These techniques reduce reliance on large sampling (e.g., pass@100) by intelligently exploring the search space to identify high-quality RTL candidates based on defined rewards.

Existing agentic systems for RTL code generation utilize multi-agent frameworks. These systems introduce agents operating at different sampling temperatures and leverage RTL simulation tools to verify functional correctness. They represent a move toward autonomous pipelines with minimal human intervention.

The above approaches face various limitations. For example, general LLM-based methods for RTL generation are limited by the lack of high-quality RTL datasets and publicly available hardware IP, which restricts model training and evaluation. Additionally, the absence of standardized benchmarks makes it difficult to measure progress or compare models meaningfully. Current approaches often emphasize functional correctness but overlook other important metrics such as design creativity or power-performance-area (PPA) considerations.

While MCTS techniques soften the brute-force nature of large-scale sampling, they struggle to handle agentic workflows that require iterative feedback processing, especially from natural language error logs. They also lack mechanisms to incorporate semantic feedback effectively, limiting their ability to refine RTL outputs based on runtime errors or verification failures.

Existing agentic systems for RTL code generation offer promising frameworks but lack transparency in evaluation metrics. Specifically, it is unclear whether their pass rates refer to generated test cases or ground truth benchmarks, making their results difficult to interpret. Furthermore, such systems often do not quantify the number of steps required for convergence, posing challenges for reproducibility and performance evaluation. No prior works systematically study the role of natural language error feedback in improving RTL generation, leaving an unexplored gap in robust, self-correcting agentic pipelines.

The agentic framework implementations described herein provide automated RTL code generation by integrating specialized LLM agents with hardware simulation tools. Self- correcting mechanisms are used, where agents iteratively refine code with progressive error feedback to ensure both compilation and functional correctness with synthesizable RTL constructs. The progressive error feedback mechanism guides LLM agents to focus on relevant error messages in a step by step process. These techniques prevent token and context overload, reduce the risk of hallucinations, and improve code refinement efficiency.

Some embodiments of the agentic system automate the iterative process of RTL design by evaluating both the design prompt and test bench. The design prompt, for example, can include user-provided data that indicates the desired behavior of the hardware design (e.g., at the register-transfer level (RTL)) and the test bench can include program code generated to verify the functionality of the hardware design (e.g., written in a hardware description language (HDL) representation or module).

In some implementations, custom agents interact with LLMs via API calls (e.g., configured on top of the agentic framework). The custom agents operate in a state-driven workflow, where each agent's output determines the next operation, thereby providing coordinated, stepwise refinement of the RTL code. The system evaluates test results at each step and updates the design prompt or logic accordingly until the RTL code passes all tests, thereby streamlining RTL code generation.

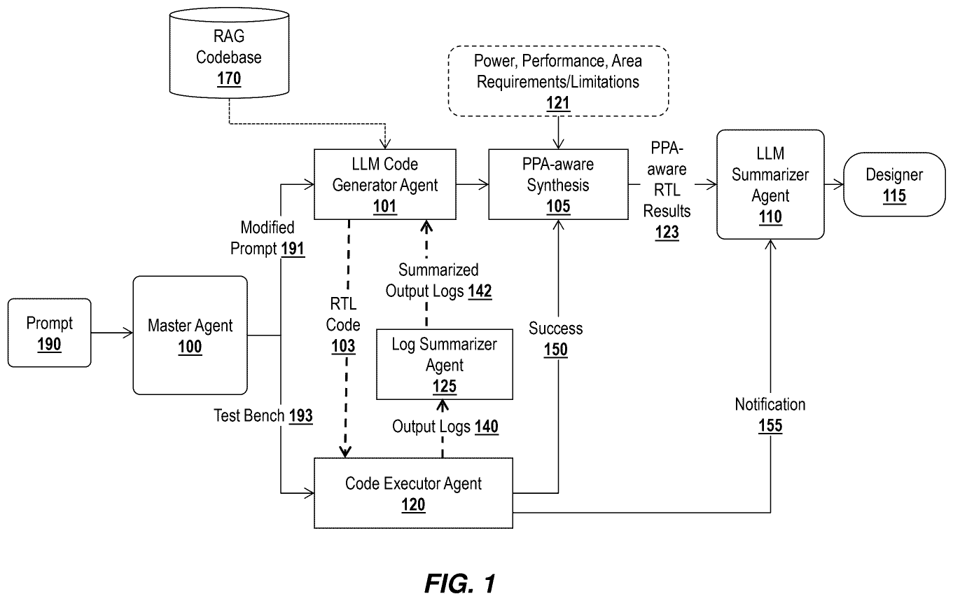

FIG. 1 illustrates an example architecture in which a master agent 100 is configured to parse the text of a design prompt 190 (e.g., a Verilog prompt) to responsively generate a modified design prompt 191 and test bench 193. As mentioned, the design prompt 190 may comprise textual or other user-provided input data that defines the hardware design at the Register-Transfer Level (RTL)) and the test bench 193 may comprise a hardware description languages (HDL) representation or software module designed to test and verify the functionality of the hardware design.

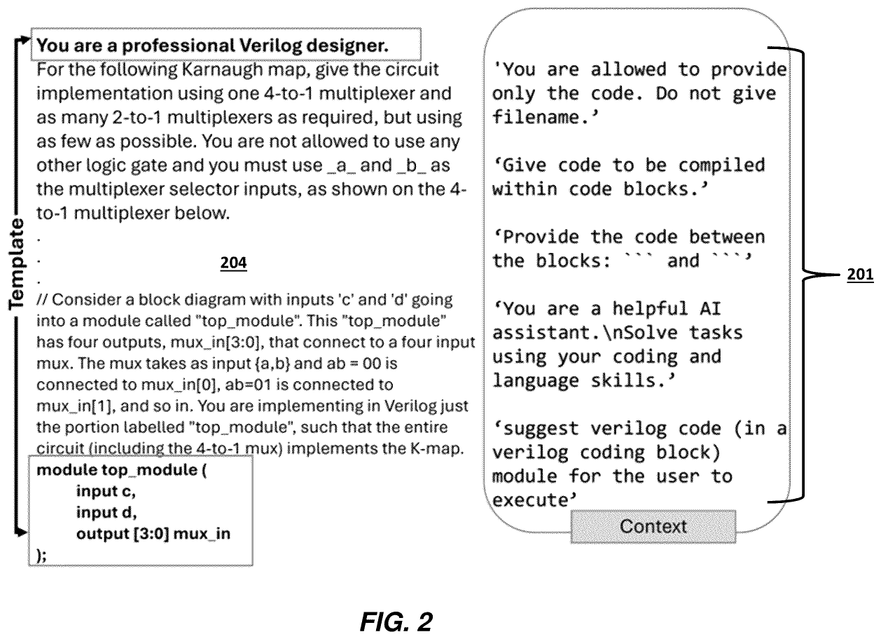

FIG. 2 illustrates an example set of design prompts 201 and a corresponding template 204. The design prompt 201 may include one or more context or system messages which are provided to the LLM code generator agent 101 in modified design prompt 191, directing the LLM code generator agent 101 to produce RTL code 103, which is subsequently executed by the code executor agent 120 as described herein. The test bench 193 may be generated in accordance with the template 204, which may comprise a modified version of an input test bench (e.g., which is modified to include the $monitor command in the test bench 193 to track input/output signal changes along with the value change dump (VCD) file).

For example, the master agent 100 may convert the input design prompt 190 into a “chain-of-thought” format in modified design prompt 191 comprising a plan for the overall execution flow and processing of the RTL code 103. The master agent 100 directs the modified design prompt 191 to the LLM code generator agent 101, which leverages the LLM in the backend to convert the modified prompt 191 into RTL code 103 to be executed by a code executor module 120. In some implementations, the LLM code generator agent 101 converts the modified prompt 191 in a zero-shot manner (e.g., without being specifically trained for the task of converting prompts into RTL code).

In some implementations, the master agent 100 is also a group manager, initializing and controlling the operation of the various other agents (e.g., code executor agent 120, log summarizer agent 125, LLM code generator agent 101, PPA-aware synthesis agent 104, and LLM summarizer agent 110) to perform the underlying operations described herein.

In some implementations, the LLM code generator agent 101 leverages a Retrieval-Augmented Generation (RAG) codebase 170 (e.g., a Verilog codebase in some implementations) to calibrate its responses within the relevant context. For example, the RAG codebase 170 enhances the capabilities of the LLM code generator agent 101 by providing it with external, up-to-date, or other application-specific information. Thus, instead of relying solely on the data the LLM code generator agent 101 was trained on, the RAG codebase 170 allow the LLM code generator agent 101 to rely on a specific knowledge base, such as a company's internal documentation or a large software repository, to generate more accurate and contextually relevant RTL code 103. Use of the RAG codebase 170 also helps to reduce “hallucinations” and improves the model's knowledge without the need for expensive and time-consuming retraining.

The master agent 100 may generate the test bench 193 to include one or more commands to track input/output signal changes (e.g., via the $monitor command to print input/output signal changes) and to indicate one or more change files to record changes in values of signals and variables during a simulation. In some implementations, this includes a template-based value change dump (VCD) file generated during RTL code execution by the code executor agent 120. These change files may be generated by one or more Electronic Design Automation (EDA) tools during the simulation of the HDL design via the code executor agent 120 to provide a detailed analysis of signal waveforms and variable states over time, which is crucial for debugging and verifying the behavior of the hardware design.

The modified test bench 193 is communicated to the code executor agent 120, which may store it in a file or as a data structure in memory for subsequent operations. The code executor agent 120 or LLM code generator agent 101 initially performs a compilation verification on the RTL code (i.e., to ensure it will properly compile) and, once verified, compiles the RTL code for execution by the code executor agent 120 in accordance with the modified test bench 193 (e.g., using Icarus Verilog (iverilog)).

The code executor agent 120 generates output logs 140 to indicate execution results, including any errors generated during execution such as mismatches between expected results and actual results. For example, when running the RTL code 103 on the modified test bench 193, the code executor agent 120 may compare generated output values with corresponding expected output values and generate indications in the output logs 140 mismatches are detected (e.g., when expected output values do not match the generated output values). In some embodiments, the code executor agent 120 runs in a virtual machine or other virtualized execution environment and implements a rule-based agent architecture to execute the RTL code 103 in accordance with the modified test bench 193.

Following execution of the RTL code 103 (or when a threshold number of mismatches or other errors have been detected), the output logs 140 indicating the errors and other results are parsed by a log summarizer agent 125 which extracts the relevant data to summarized output logs 142 (e.g., filtering out unnecessary data and/or aggregating results).

In some implementations, the LLM code generator agent 101 evaluates the summarized output logs 142 to implement targeted changes to the RTL code 103, with the goal of eliminating the errors. Following the changes, the modified RTL code 103 is compiled and executed by the code executor agent 120 in a second iteration in accordance with the modified test bench 193. This process repeats until the compiled RTL code is error-free or until a threshold number of iterations has been reached. Each time a new error is detected in an iteration, the error is recorded in the output logs 140, 142 and evaluated by the LLM code generator agent 101 to make additional targeted modifications to the RTL code 103.

In some embodiments, the process terminates and a notification is sent to the designer 115 when a threshold number of iterations is reached. For example, in one embodiment, the number of compile attempts and executions by the code executor agent 120 are counted until a threshold value (N) is reached (e.g., N=4). On the first attempted compilation of the RTL code 103 (by the LLM code generator agent 101 or code executor agent 120), a counter is set to 1 (i.e., N=1) and is incremented for each subsequent compilation attempt (if any) and for each execution of a new instance of the RTL code 103 based on the modified test bench 193. If the counter value, N, reaches the threshold, then the process terminates and a notification 155 is sent to the designer 115 to indicate that user intervention is needed. For example, if N=4 and the RTL code 103 was successfully compiled in two attempts, then the code execution agent 120 will have two chances to successfully execute the RTL code 103 with no errors before the designer 115 is sent the notification 155.

When the code executor agent 120 successfully executes the RTL code 103 without errors, a success indication 150 is generated to indicate that the RTL code 103 is reliable. In some implementations, the resulting RTL code 103 is sent to a power, performance, area (PPA)-aware synthesis agent 105 which evaluates and further refines the RTL code in view of specified power, performance, and area requirements/limitations 121. For example, if the hardware represented in the RTL code is intended for use in a mobile device, then the PPA-aware synthesis agent 105 may generate RTL code results 123 designed for high-efficiency, reduced power operation while maintaining an acceptable level of performance and consuming a reasonable amount of chip area. Conversely, if the hardware is intended for use in a workstation or server, the PPA-aware synthesis agent 105 may generate RTL code results 123 weighted towards the highest achievable performance, given the maximum power and silicon area requirements. More generally, the PPA requirements/limitations 121 may indicate minimum and maximum values for power, performance, and area, which the PPA-aware synthesis agent 105 uses to generate the RTL code results 123 in accordance with the intended use of the hardware.

The PPA-aware RTL results 123 are provided to an LLM summarizer agent 110 which parses and organizes information for review by a designer 115. For example, in addition to the final RTL code configured in accordance with PPA requirements/limitations, the LLM summarizer agent 110 generates a report indicating the success or failure of the attempted code generation including a summary of the entire transaction history. In these implementations, the summary can include information related to one or more of: failed compilations, errors in each attempted execution, the PPA settings, test bench modifications, and/or changes to the RTL code made by the LLM code generator agent 101 for each iteration. The LLM summarizer agent 110 may operate similarly to the log summarizer agent 125 but operates on a larger set of transactions.

The agentic system described herein provides a coherent platform for LLM-based RTL code generation with context-based information a designer 115 can use for performing additional modifications to the RTL code. These implementations provide for minimal intervention by the designer 115, as the summarized output of the entire sequence of transactions provide insights into the progress of the LLM code generator agent 101, ensuring that the LLM code generator agent 101 adheres to the initial instructions and avoids hallucinations. Upon review, the designer 115 may determine whether the results are acceptable or whether an intervention is needed.

Thus, the techniques described herein are implemented through a combination of a hybrid plurality of programmatic smart agents (“hybrid agents”) 100-101, 105, 110, 120 (e.g., comprising a mixture of design tools and LLMs) and progressive feedback. In some implementations, to optimize efficiency and protect intellectual property (IP), the test bench is treated as a black-box—sharing only the resulting output logs with the model 140 (e.g., with the LLM code generator agent 101 via the log summarizer agent 125). This approach maintains strong performance while reducing overhead and preserving design confidentiality.

Specialized commands are included in some implementations to ensure syntactic correctness. By way of example, and not limitation, this can include linting commands in Verilator with the -Wall flag. Linting tools are included in some implementations for static analysis of generated RTL code to identify potential issues such as syntax errors, semantic problems, and non-synthesizable constructs. At any stage—linting, compilation, or testing—if a failure occurs, the process is terminated and the corresponding stack trace is encoded in the output logs 140, summarized output logs 142 and/or results 123.

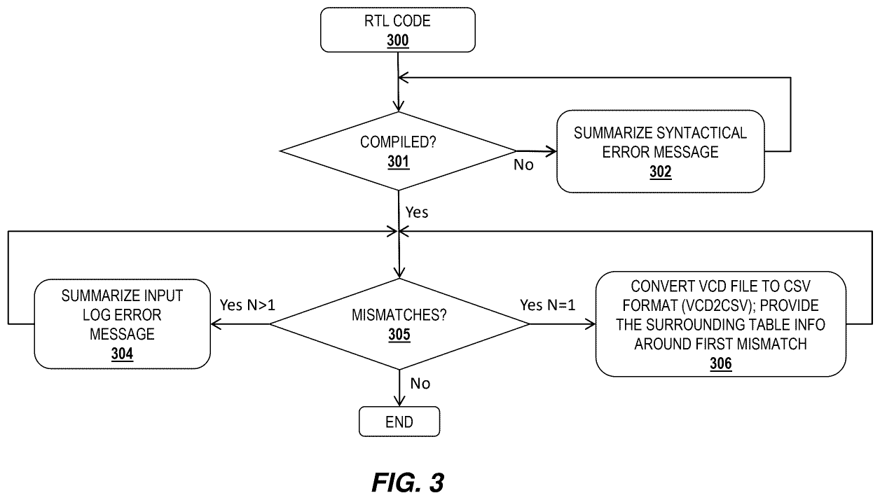

FIG. 3 illustrates a method corresponding to a state flow in accordance with some implementations. The method may be performed, for example, by the smart agents or a subset thereof (e.g., the LLM code generator agent 101, code executor agent 120, and log summarizer agent 125). In compilation check 301, a determination is made as to whether the RTL code 300 produced by the LLM code generator agent 101 compiles successfully. If the attempted compilation of the RTL code is unsuccessful, the corresponding syntactical error message(s) are summarized at 302. The summarization may be perform by another LLM-based summarizer agent, which may have fewer resource requirements than the LLM code generator agent 101 (i.e., may be a “smaller” LLM). The summarized information may be used by the LLM code generator agent 101 and/or the designer 115 to modify the RTL code in subsequent compilation attempts and iterations.

On the first attempt to compile the RTL code at 301, a feedback loop counter N is initialized (e.g., starting from N=1) and incremented on each compilation attempt. Once compilation is successful, the compiled RTL code is provided to the code executor agent 120 and the counter value is maintained. If there are any mismatches resulting from execution of the RTL code by the executor agent at 305, then additional operations are performed based on the counter value.

If mismatches are detected while the counter value, N=1 (i.e., following a successful initial compilation attempt), then at 306, the simulation output information (e.g., stored in a VCD file) is parsed and converted to defined format, such as a comma separated value (CSV) format. While CSV is used here as an example universally accessible format, the underlying principles described herein are not limited to any particular data format or file format. Additionally, tabulated information surrounding the first signal mismatch may be provided for debugging.

When mismatches are detected in subsequent iterations, with the counter value, N, greater than 1, the input log error messages are summarized at 304 to aid in debugging (e.g., by another, potentially smaller LLM). Mismatch checks continue to be performed at 305 until the RTL code is successfully executed with no mismatches and/or until a maximum value of N is reached (e.g., N=4), at which point the process ends.

Thus, instead of feeding the full error logs at each step, the problem-solving process is logically partitioned into multiple progressive error feedback operations. All or portions of this logical flow may be implemented in the various hybrid agents to enable progressive error feedback. Content manipulation is employed in some of these implementations to address the misinterpretation of instructions by LLMs resulting from long feedback outputs, which can hinder agentic system performance. In particular, one or both of the following strategies may be applied:
Log Summarizer agent 125: Only the most recent output from the code executor agent 120 is passed to the log summarizer agent 125, preventing information overload. Previous messages from the group messaging stack may be cleared to ensure focused processing.
Code context management: A queue of generated code and logs is maintained, ensuring that the code creator only sees the latest compilable RTL code along with the latest feedback. This maintains a minimal but relevant agent context, improving the response accuracy.

When evaluated with specific benchmark dataset, the implementations described herein improve performance across all models and significantly narrows the gap between open- and closed-source solutions. Results show state-of-the-art accuracy and efficiency, supported by reduced token usage for certain outputs. Thus, integrating agents into the workflow enables faster identification of optimal design solutions with reduced human intervention, ultimately accelerating time to market.

As discussed earlier, a single agentic cycle may be limited to a maximum number of LLM calls (e.g., N=4). Compared to a baseline using a non-agentic approach in which no feedback is provided from the execution trace, the embodiments described herein provide notable performance improvements. The agentic approach described herein improves test pass rates, indicating enhanced problem-solving capabilities over non-agentic methods. Closed-source models (e.g., GPT-40, GPT-4, Claude-3.5-Sonnet) achieve test pass rate increases in the range of 10% to 32% while open-source models (e.g., Llama 3.1:8B Inst, Llama 3.1:70B Inst, DeepSeekCoder-33B) show increases ranging from 24% to 135%. These results highlight the performance gains enabled by agentic reasoning, effectively narrowing the gap between open-source and closed-source models.

Furthermore, in the case of twenty LLM calls—where success is defined as achieving at least one pass out of twenty attempts—improvements are observed across all models. Importantly, these implementations significantly reduce the number of LLM calls required compared to non-agentic implementations. From a computational efficiency standpoint, reducing API calls enhances performance, making it a promising foundation for self-correcting LLMs.

When the impact of progressive feedback is examined, consistent improvements across both open-source and closed-source models are observed. In contrast, simple feedback—where all log data is provided to the LLM at once without any progression—results in lower performance.

Token usage in the baseline implementations and the agentic workflow implementations described herein were evaluated to assess computational efficiency. The baseline implementations (e.g., Claude-3.5-Sonnet, pass@20) average approximately 440 tokens per call (390 input tokens+50 output tokens). In comparison, the agentic implementations descried herein maintain a similar token count per problem but differ in structure. The initial LLM call uses approximately 440 tokens, and each subsequent iteration adds approximately 600 tokens from summarized logs of the compiled RTL code. This leads to an average of 1,040 tokens per follow-up call, totaling about 3,560 tokens over four calls (440+3×1,040). Despite the added 600-token overhead per iteration, the implementations described herein reduce the number of LLM calls from 20 to 4, significantly improving overall efficiency.

Detailed below are descriptions of exemplary computer and processor architectures on which the embodiments described herein may be implemented. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

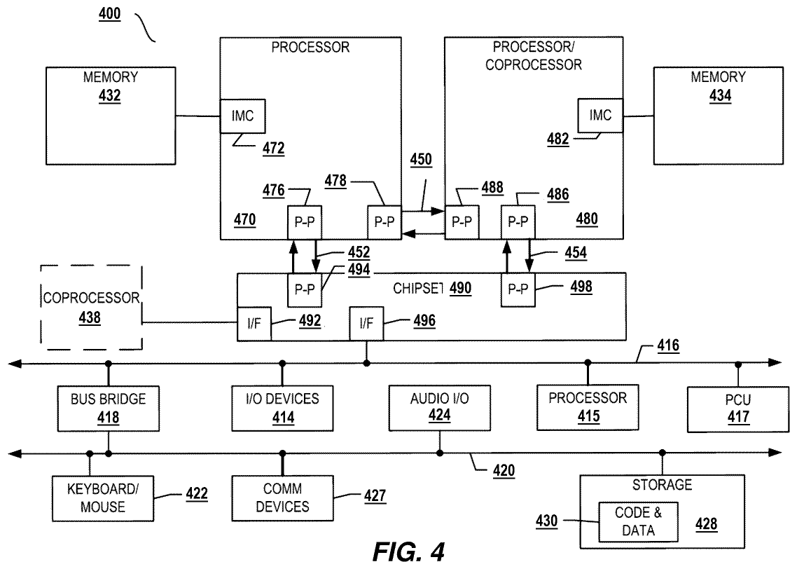

FIG. 4 illustrates embodiments of an exemplary multiprocessor system 400 comprising a point-to-point interconnect system with a plurality of processors including a first processor 470 and a second processor 480 coupled via a point-to-point interconnect 450. The various components of the multiprocessor system 400, including the first and second processors 470, 480 may be integrated on a single semiconductor chip (i.e., in a system-on-chip (SoC) implementation), multiple chips on a single package (i.e., a multi-chip module), or distributed across multiple processor packages coupled via multiple corresponding motherboard sockets.

The first processor 470 and the second processor 480 may be homogeneous (e.g., with the same microarchitecture) or heterogeneous (e.g., having different microarchitectures for executing different sets of instructions). For example, the first processor 470 may be a general purpose processor such as an x86 or ARM-based architecture and the second processor 480 may be a hardware accelerator such as a general purpose graphics processor (GPGPU) or neural processing unit (NPU) for executing machine learning kernels. In such an implementation, the first processor 470 may schedule the kernels for execution on the second processor 480. The machine learning kernels may include one or more instructions for performing matrix operations (e.g., convolutions, matrix multiplications) on the parallel execution hardware of the second processor 480. By way of example, and not limitation, the LLM code generator agent 101, the code executor agent 120, the log summarizer agent 125, and various other components of the agentic LLM framework described herein may comprise kernel program code executed on the second processor 480. It should be noted, however, that the underlying principles of this disclosure are not limited to any particular system or processor architecture.

Processors 470 and 480 are shown including integrated memory controller (IMC) units circuitry 472 and 482, respectively. Processor 470 also includes as part of its interconnect controller units point-to-point (P-P) interfaces 476 and 478; similarly, second processor 480 includes P-P interfaces 486 and 488. Processors 470, 480 may exchange information via the point-to-point (P-P) interconnect 450 using P-P interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a chipset 490 via individual P-P interconnects 452, 454 using point to point interface circuits 476, 494, 486, 498. Chipset 490 may optionally exchange information with a coprocessor 438 via a high-performance interface 492. In some embodiments, the coprocessor 438 is a special-purpose processor, such as, for example, a high-throughput general purpose graphics processor (GPGPU) or neural processing unit (NPU). In cases where the second processor 480 is a machine learning accelerator, the coprocessor 438 may comprise a similar or different form of accelerator. For example, the coprocessor 438 may comprise an integrated GPGPU or NPU while the second processor 480 may comprise a discrete GPGPU or NPU.

A shared cache (not shown) may be included in either processor 470, 480 or outside of both processors, yet connected with the processors via P-P interconnect, such that either or both processors' local cache information may be stored in the shared cache if a processor is placed into a low power mode.

Chipset 490 may be coupled to a first interconnect 416 via an interface 496. In some embodiments, first interconnect 416 may be a Peripheral Component Interconnect (PCI) interconnect, or an interconnect such as a PCI Express interconnect or another I/O interconnect. In some embodiments, one of the interconnects couples to a power control unit (PCU) 417, which may include circuitry, software, and/or firmware to perform power management operations with regard to the processors 470, 480 and/or co-processor 438. PCU 417 provides control information to a voltage regulator to cause the voltage regulator to generate the appropriate regulated voltage. PCU 417 also provides control information to control the operating voltage generated. In various embodiments, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other embodiments, power management operations to be performed by PCU 417 may be implemented externally to a processor, such as by way of a separate power management integrated circuit (PMIC) or another component external to the processor. In yet other embodiments, power management operations to be performed by PCU 417 may be implemented within BIOS or other system software.

Various I/O devices 414 may be coupled to first interconnect 416, along with an interconnect (bus) bridge 418 which couples first interconnect 416 to a second interconnect 420. In some embodiments, one or more additional processor(s) 415, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 416. In some embodiments, second interconnect 420 may be a low pin count (LPC) interconnect. Various devices may be coupled to second interconnect 420 including, for example, a keyboard and/or mouse 422, communication devices 427 and a storage unit circuitry 428. Storage unit circuitry 428 may be a disk drive or other mass storage device which may include instructions/code and data 430, in some embodiments. Further, an audio I/O 424 may be coupled to second interconnect 420. Note that other architectures than the point-to-point architecture described above are possible. For example, instead of the point-to-point architecture, a system such as multiprocessor system 400 may implement a multi-drop interconnect or other such architecture.

### EXAMPLES

The following are example implementations of the present disclosure.

Example 1. A machine-readable storage medium having program code stored thereon which, when executed by one or more processors, is to cause the one or more processors to implement an agentic framework for automated register-transfer level (RTL) code generation, the agentic framework comprising: a large language model (LLM) code generator agent to generate initial RTL code based on a design prompt and to iteratively generate refined RTL code in accordance with error feedback; and a code executor agent to execute the initial RTL code in accordance with a test bench, the code executor agent to generate a validation indication when the initial RTL code can be executed without errors or to record a first one or more detected errors generated during execution of the initial RTL code, the LLM code generator agent to evaluate the first one or more detected errors to generate first refined RTL code and to provide the first refined RTL code for execution by the code executor agent.

Example 2. The machine-readable storage medium of Example 1, wherein the code executor agent is to execute the first refined RTL code in accordance with the test bench, or a modified version thereof, the code executor agent to generate the validation indication when the first refined RTL code can be executed without errors or to communicate a second one or more detected errors to the LLM code generator agent, wherein the LLM code generator agent is to evaluate the second one or more detected errors to generate second refined RTL code and to provide the second refined RTL code for execution by the code executor agent.

Example 3. The machine-readable storage medium of Examples 1 or 2, wherein at least one of the first one or more detected errors comprises a mismatch between an expected result and an actual result generated during execution by the code executor agent.

Example 4. The machine-readable storage medium any of Examples 1 to 3, wherein the code executor agent is to generate one or more output logs indicating the first one or more errors, the agentic framework further comprising: a log summarizer agent to extract relevant error data from the one or more output logs to generate one or more summarized output logs to be used by the LLM code generator agent to generate the first refined RTL code.

Example 5. The machine-readable storage medium of any of Examples 1 to 4, wherein at least one of the LLM code generator agent and the code executor agent is to compile the initial RTL code and the first refined RTL code prior to execution by the code executor agent.

Example 6. The machine-readable storage medium any of Example 1 to 5, wherein a counter value is to be initialized upon successful compilation of the initial RTL code and is to be incremented in response to any subsequent failed attempts to compile the refined RTL code, the counter value to be further incremented in response to the code executor agent detecting one or more errors during execution of the initial RTL code or the first refined RTL code, wherein when the counter value reaches a threshold, a notification is to be generated to indicate that user intervention is required.

Example 7. The machine-readable storage medium any of Example 1 to 6, wherein the agentic framework further comprises: a power, performance, area (PPA)-aware synthesis agent to evaluate the initial RTL code or first refined RTL code in view of specified power, performance, and area requirements and to perform additional refinements to generate result RTL code in accordance with the power, performance, and area requirements.

Example 8. The machine-readable storage medium of any of Examples 1 to 7, wherein the agentic framework further comprises: a master agent to provide the design prompt, or a modified version thereof, to the LLM code generator agent and to provide the test bench, or a modified version thereof, to the code executor agent.

Example 9. A method performed by an agentic framework for automated register-transfer level (RTL) code generation, the method comprising: generating initial RTL code by a large language model (LLM) code generator agent based on a design prompt; executing the RTL code by a code executor agent in accordance with a test bench; generating a validation indication when the initial RTL code can be executed without errors or recording a first one or more detected errors generated during execution of the initial RTL code, evaluating the first one or more detected errors by the LLM code generator agent to generate refined RTL code; and providing the refined RTL code for execution by the code executor agent.

Example 10. The method of Example 9, further comprising: executing, by the code executor agent, the first refined RTL code in accordance with the test bench, or a modified version thereof; generating the validation indication when the first refined RTL code can be executed without errors or recording a second one or more detected errors generated during execution of the refined RTL code; evaluating, by the LLM code generator agent, the second one or more detected errors to generate second refined RTL code; and providing the second refined RTL code for execution by the code executor agent.

Example 11. The method of Example 9 or 10, wherein at least one of the first one or more detected errors comprises a mismatch between an expected result and an actual result generated during execution by the code executor agent.

Example 12. The method any of Examples 9 to 11, further comprising generating one or more output logs indicating the first one or more errors, the agentic framework further comprising: a log summarizer agent to extract relevant error data from the one or more output logs to generate one or more summarized output logs to be used by the LLM code generator agent to generate the first refined RTL code.

Example 13. The method of any of Examples 9 to 12, further comprising: compiling the initial RTL code and the first refined RTL code prior to execution by the code executor agent.

Example 14. The method any of Examples 9 to 13, further comprising: initializing a counter value upon successful compilation of the initial RTL code; incrementing the counter value in response to any subsequent failed attempts to compile the refined RTL code; further incrementing the counter value in response to the code executor agent detecting the first one or more detected errors or a second one or more detected errors during execution of the initial RTL code or the first refined RTL code, respectively; and generating a notification to indicate that user intervention is required when the counter value reaches a threshold.

Example 15. The method any of Examples 9 to 14, further comprising: evaluating the initial RTL code or first refined RTL code by a power, performance, area (PPA)-aware synthesis agent in view of specified power, performance, and area requirements; and performing additional refinements to generate result RTL code in accordance with the power, performance, and area requirements.

Example 16. The method of any of Examples 9 to 15, further comprising: providing, by a master agent, the design prompt or a modified version thereof, to the LLM code generator agent; and providing, by the master agent, the test bench, or a modified version thereof, to the code executor agent.

Example 17. A system comprising one or more processors to execute program code to implement an agentic framework for automated register-transfer level (RTL) code generation, the agentic framework comprising: a large language model (LLM) code generator agent to generate initial RTL code based on a design prompt and to iteratively generate refined RTL code in accordance with error feedback; and a code executor agent to execute the initial RTL code in accordance with a test bench, the code executor agent to generate a validation indication when the initial RTL code can be executed without errors or to record a first one or more detected errors generated during execution of the initial RTL code, the LLM code generator agent to evaluate the first one or more detected errors to generate first refined RTL code and to provide the first refined RTL code for execution by the code executor agent.

Example 18. The system of Example 17, wherein the code executor agent is to execute the first refined RTL code in accordance with the test bench, or a modified version thereof, the code executor agent to generate the validation indication when the first refined RTL code can be executed without errors or to communicate a second one or more detected errors to the LLM code generator agent, wherein the LLM code generator agent is to evaluate the second one or more detected errors to generate second refined RTL code and to provide the second refined RTL code for execution by the code executor agent.

Example 19. The system of Example 17 or 18, wherein at least one of the first one or more detected errors comprises a mismatch between an expected result and an actual result generated during execution by the code executor agent.

Example 20. The system any of Examples 17 to 19, wherein the code executor agent is to generate one or more output logs indicating the first one or more errors, the agentic framework further comprising: a log summarizer agent to extract relevant error data from the one or more output logs to generate one or more summarized output logs to be used by the LLM code generator agent to generate the first refined RTL code.

Disclosed herein are embodiments of instructions, embodiments of processors to perform the instructions, embodiments of methods performed by the processors when performing the instructions, embodiments of systems incorporating one or more processors to perform the instructions, and embodiments of programs or machine-readable mediums storing or otherwise providing the instructions. In the following description, numerous specific details are set forth (e.g., specific instruction operations, data formats, processor configurations, microarchitectural details, sequences of operations, etc.). However, embodiments may be practiced without these specific details. In other instances, well-known circuits, structures, and techniques have not been shown in detail to avoid obscuring the understanding of the description.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A machine-readable storage medium having program code stored thereon which, when executed by one or more processors, is to cause the one or more processors to implement an agentic framework for automated register-transfer level (RTL) code generation, the agentic framework comprising:
a large language model (LLM) code generator agent to generate initial RTL code based on a design prompt and to iteratively generate refined RTL code in accordance with error feedback; and
a code executor agent to execute the initial RTL code in accordance with a test bench, the code executor agent to generate a validation indication when the initial RTL code can be executed without errors or to record a first one or more detected errors generated during execution of the initial RTL code,
the LLM code generator agent to evaluate the first one or more detected errors to generate first refined RTL code and to provide the first refined RTL code for execution by the code executor agent.

2. The machine-readable storage medium of claim 1, wherein when the code executor agent records the first one or more detected errors and the LLM code generator agent generates the first refined RTL code, the code executor agent is further to execute the first refined RTL code in accordance with the test bench, or a modified version thereof, the code executor agent to generate the validation indication when the first refined RTL code can be executed without errors or to communicate a second one or more detected errors to the LLM code generator agent, wherein the LLM code generator agent is to evaluate the second one or more detected errors to generate second refined RTL code and to provide the second refined RTL code for execution by the code executor agent.

3. The machine-readable storage medium of claim 1, wherein at least one of the first one or more detected errors comprises a mismatch between an expected result and an actual result generated during execution by the code executor agent.

4. The machine-readable storage medium of claim 3, wherein the code executor agent is to generate one or more output logs indicating the first one or more errors, the agentic framework further comprising:
a log summarizer agent to extract relevant error data from the one or more output logs to generate one or more summarized output logs to be used by the LLM code generator agent to generate the first refined RTL code.

5. The machine-readable storage medium of claim 1, wherein at least one of the LLM code generator agent and the code executor agent is to compile the initial RTL code and the first refined RTL code prior to execution by the code executor agent.

6. The machine-readable storage medium of claim 5, wherein a counter value is to be initialized upon successful compilation of the initial RTL code and is to be incremented in response to any subsequent failed attempts to compile the refined RTL code, the counter value to be further incremented in response to the code executor agent detecting one or more errors during execution of the initial RTL code or the first refined RTL code, wherein when the counter value reaches a threshold, a notification is to be generated to indicate that user intervention is required.

7. The machine-readable storage medium of claim 5, wherein the agentic framework further comprises:
a power, performance, area (PPA)-aware synthesis agent to evaluate the initial RTL code or first refined RTL code in view of specified power, performance, and area requirements and to perform additional refinements to generate result RTL code in accordance with the power, performance, and area requirements.

8. The machine-readable storage medium of claim 1, wherein the agentic framework further comprises:
a master agent to provide the design prompt, or a modified version thereof, to the LLM code generator agent and to provide the test bench, or a modified version thereof, to the code executor agent.

9. The machine-readable storage medium of claim 1, wherein the LLM code generator agent is to generate the initial RTL code and the first refined RTL code in accordance with a Retrieval-Augmented Generation (RAG) codebase comprising application-specific information.

10. A method performed by an agentic framework for automated register-transfer level (RTL) code generation, the method comprising:
generating initial RTL code by a large language model (LLM) code generator agent based on a design prompt;
executing the RTL code by a code executor agent in accordance with a test bench;
generating a validation indication when the initial RTL code can be executed without errors or recording a first one or more detected errors generated during execution of the initial RTL code,
evaluating the first one or more detected errors by the LLM code generator agent to generate refined RTL code; and
providing the refined RTL code for execution by the code executor agent.

11. The method of claim 10, further comprising:
executing, by the code executor agent, the first refined RTL code in accordance with the test bench, or a modified version thereof;
generating the validation indication when the first refined RTL code can be executed without errors or recording a second one or more detected errors generated during execution of the refined RTL code;
evaluating, by the LLM code generator agent, the second one or more detected errors to generate second refined RTL code; and
providing the second refined RTL code for execution by the code executor agent.

12. The method of claim 10, wherein at least one of the first one or more detected errors comprises a mismatch between an expected result and an actual result generated during execution by the code executor agent.

13. The method of claim 12, further comprising generating one or more output logs indicating the first one or more errors, the agentic framework further comprising:
a log summarizer agent to extract relevant error data from the one or more output logs to generate one or more summarized output logs to be used by the LLM code generator agent to generate the first refined RTL code.

14. The method of claim 10, further comprising:
compiling the initial RTL code and the first refined RTL code prior to execution by the code executor agent.

15. The method of claim 14, further comprising:
initializing a counter value upon successful compilation of the initial RTL code;
incrementing the counter value in response to any subsequent failed attempts to compile the refined RTL code;
further incrementing the counter value in response to the code executor agent detecting the first one or more detected errors or a second one or more detected errors during execution of the initial RTL code or the first refined RTL code, respectively; and
generating a notification to indicate that user intervention is required when the counter value reaches a threshold.

16. The method of claim 14, further comprising:
evaluating the initial RTL code or first refined RTL code by a power, performance, area (PPA)-aware synthesis agent in view of specified power, performance, and area requirements; and
performing additional refinements to generate result RTL code in accordance with the power, performance, and area requirements.

17. The method of claim 10, further comprising:
providing, by a master agent, the design prompt or a modified version thereof, to the LLM code generator agent; and
providing, by the master agent, the test bench, or a modified version thereof, to the code executor agent.

18. The method of claim 10, further comprising: generating, by the LLM code generator agent, the initial RTL code and the first refined RTL code in accordance with a Retrieval-Augmented Generation (RAG) codebase comprising application-specific information.

19. A system comprising one or more processors to execute program code to implement an agentic framework for automated register-transfer level (RTL) code generation, the agentic framework comprising:
a large language model (LLM) code generator agent to generate initial RTL code based on a design prompt and to iteratively generate refined RTL code in accordance with error feedback; and
a code executor agent to execute the initial RTL code in accordance with a test bench, the code executor agent to generate a validation indication when the initial RTL code can be executed without errors or to record a first one or more detected errors generated during execution of the initial RTL code,
the LLM code generator agent to evaluate the first one or more detected errors to generate first refined RTL code and to provide the first refined RTL code for execution by the code executor agent.

20. The system of claim 19, wherein the code executor agent is to execute the first refined RTL code in accordance with the test bench, or a modified version thereof, the code executor agent to generate the validation indication when the first refined RTL code can be executed without errors or to communicate a second one or more detected errors to the LLM code generator agent, wherein the LLM code generator agent is to evaluate the second one or more detected errors to generate second refined RTL code and to provide the second refined RTL code for execution by the code executor agent.
